(19) United States
(12) Patent Application Publication
(10) Pub. No.: US 2016/0210291 A1
(43) Pub. Date: Jul. 21, 2016

(54) Historical Presentation of Search Results

(71) Applicants: Kevin A. Li, New York, NY (US); Anthony Ko-Ping Chien, Foster City, CA (US)

(72) Inventors: Kevin A. Li, New York, NY (US); Anthony Ko-Ping Chien, Foster City, CA (US)

(21) Appl. No.: 14/991,079

(22) Filed: Jan. 8, 2016

Related U.S. Application Data
(60) Provisional application No. 62/105,973, filed on Jan. 21, 2015.

(51) Int. Cl. G06F 17/30; G06F 17/27

(52) U.S. Cl. CPC G06F 17/3053; G06F 17/30554; G06F 17/30598; G06F 17/2705; G06F 17/3089; G06F 17/30864

(57) ABSTRACT

Methods, systems, and products historically arrange search results according to subject matter. A database of content associates different website links to different classifications of subject matter. The database of content, however, also associates each website link as an event in a timeline of events related to the subject matter. When the database of content is queried for the subject matter, search results are historically arranged.

### CROSS-REFERENCE TO RELATED APPLICATION

This application claims the benefit of U.S. Provisional Application 62/105,973 filed Jan. 21, 2015.

### BACKGROUND

Nearly everyone reads the news. Most readers obtain their news from major news publisher websites, such as USA TODAY, CNN, ABC, BBC, and FOX NEWS. However, in today's 24-hour news cycle, news sources chase the latest headlines. News publishers, in other words, focus on breaking news and nearly ignore historic details.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 is a simplified schematic illustrating an environment in which exemplary embodiments may be implemented;

FIGS. 2-4 are screenshots of graphical user interfaces, according to exemplary embodiments;

FIG. 5 is a more detailed schematic illustrating the operating environment, according to exemplary embodiments;

FIGS. 6 and 7 are more detailed schematics illustrating a database of content, according to exemplary embodiments;

FIG. 8 is a flowchart illustrating a method or algorithm for populating the entries in the database of content, according to exemplary embodiments;

FIG. 9 is a flowchart illustrating a method or algorithm for training a classifier, according to exemplary embodiments; and

FIG. 10 depicts still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

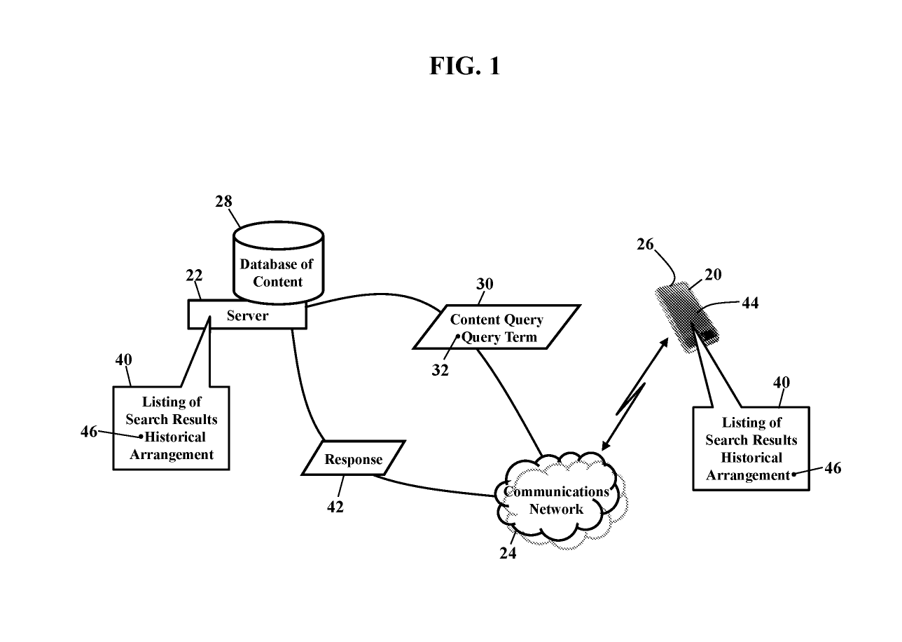

FIG. 1 is a schematic illustrating an environment in which exemplary embodiments may be implemented. FIG. 1 illustrates a client device 20 that communicates with a server 22 via a communications network 24. The client device 20, for simplicity and familiarity, is illustrated as a mobile smartphone 26. The client device 20, however, may be any other mobile or stationary device, as later paragraphs will explain. Regardless, the server 22 stores a database 28 of content. When a user of the smartphone 26 wishes to retrieve some subject matter (such as a news article), the user's smartphone 26 submits a content query 30 to the server 22. The content query 30 includes or specifies a query term 32. The query term 32 is any keyword, subject, or other search term entered by the user. When the server 22 receives the content query 30, the server 22 queries the database 28 of content for the query term 32. The server 22 generates a listing 40 of search results that match the query term 32. The server 22 sends the listing 40 of search results as a response 42 to the smartphone 26. The smartphone 26 processes the listing 40 of search results for display on a display device 44. The user of the smartphone 26 may thus peruse the listing 40 of search results for content related to the query term 32. In a news environment, the listing 40 of search results typically includes news articles and even advertisements that are related to the query term 32.

Here, though, exemplary embodiments may historically arrange search results. As the server 22 generates the listing 40 of search results, the server 20 may historically arrange the search results. That is, the server 22 may arrange the listing 40 of search results in an historical arrangement 46. When the user's smartphone 26 processes the listing 40 of search results, the search results are displayed in the historical arrangement 46. Exemplary embodiments, for example, may chronologically arrange the listing 40 of search results. A chronological arrangement allows the reading user to quickly delve into historical articles and details for a much quicker historical context. However, the historical arrangement 46 may arrange the listing 40 of search results according to sequential position, scholarly contribution, intellectual advancement, or any other criterion, as later paragraphs will explain.

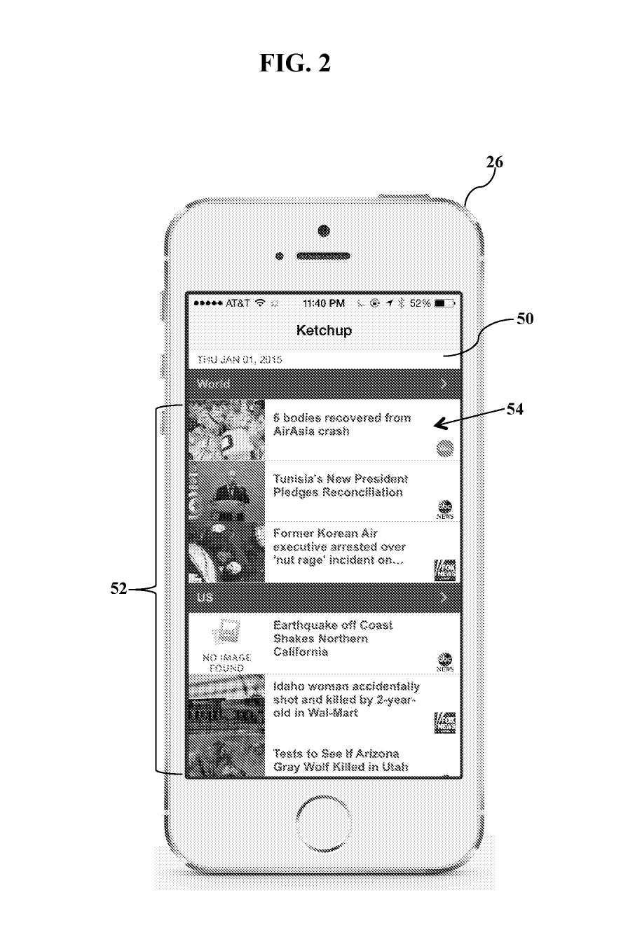

FIGS. 2-4 are screenshots of graphical user interfaces, according to exemplary embodiments. FIGS. 2-4 illustrate an interface 50 for a newsreader application, but exemplary embodiments may historically arrange any search results (again, as later paragraphs will explain). The smartphone 26 is shown displaying a listing 52 of headline news articles. FIG. 2, for example, illustrates several major headlines for a day, including an entry 54 for a tragic airline event. Assuming the user wishes to learn more about the tragic airline event, the user touches or otherwise selects the entry 54 to query for and retrieve the corresponding website news article. The user's selection causes the smartphone 26 to send the content query (illustrated as reference numeral 30 in FIG. 1).

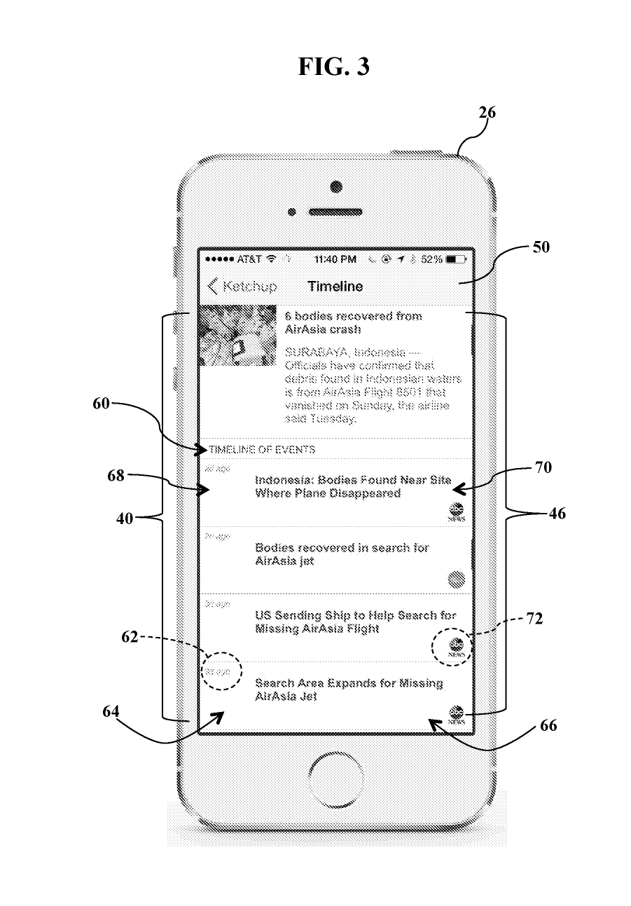

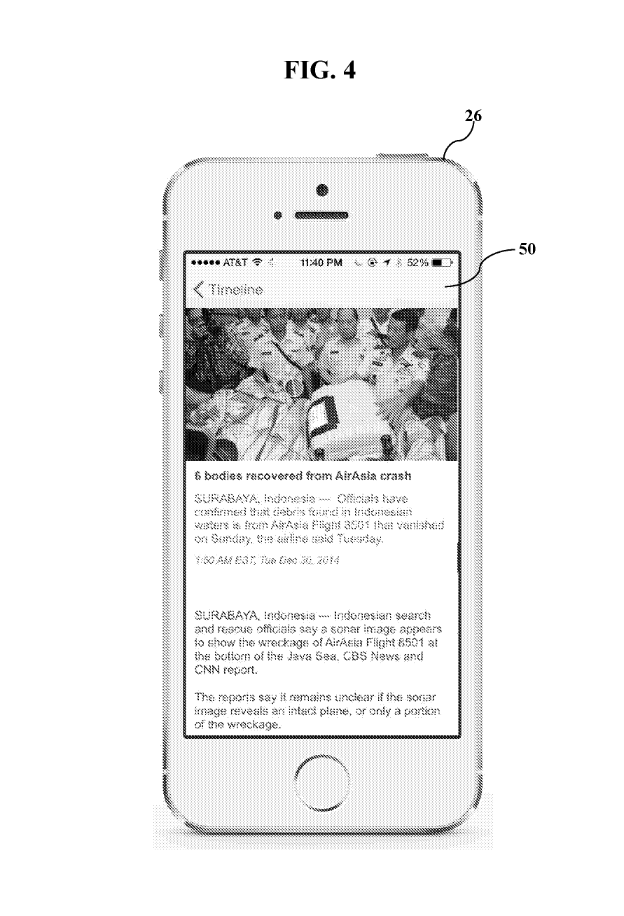

FIG. 3 thus illustrates the search results related to the tragic airline event. Here, though, the listing 40 of search results has the historical arrangement 46. That is, the listing 40 of search results is arranged and displayed according to a timeline 60 of events. Each one of the entries in the listing 40 of search results is historically arranged from initial reports to current updates related to the user's selected entry (e.g., the tragic airline event illustrated as entry 54 in FIG. 2). That is, exemplary embodiments may chronologically arrange the search results according to historical events. FIG. 3, for simplicity, illustrates news articles historically arranged by a publication date 62, with an older entry 64 at or near a bottom 66 of the listing 40 of search results. Newer electronic articles may be presented in chronologically ascending order, with a most recent entry 68 at or near a top 70 of the listing 40 of search results. Exemplary embodiments thus historically arrange the entries in the listing 40 of search results, even though the search results are assembled from different news/data sources 72 (e.g., ABC NEWS and USA TODAY). The user may thus chronologically scan the relevant headlines related to the same news event subject. If the user wishes to “drill down” by time to an older article, the user need only touch or otherwise select the headline entry having the desired past date. So, when the user selects an individual entry in the listing 40 of search results, exemplary embodiments then query for and retrieve the corresponding entry. FIG. 4, for example, illustrates the smartphone 26 retrieving and displaying an article's website link to a full text description of the corresponding article.

Exemplary embodiments are thus an intellectual catch up mechanism. When the user queries for any subject matter, exemplary embodiments may present the historical arrangement 46 of the search results. The search results are thus displayed for historical background, allowing the user to probe backwards in the news cycle for past articles, blogs, websites, or other entries. While FIG. 3 arranges the entries by the publication date 62, exemplary embodiments may historically arrange by any other time-based indication, timestamp, or metadata. Regardless, conventional newsreaders only push the newest news, thus forcing the user to comb and dig for historical context. Exemplary embodiments, instead, present an intelligent newsreader application that fosters quick and easy background updates according to subject matter.

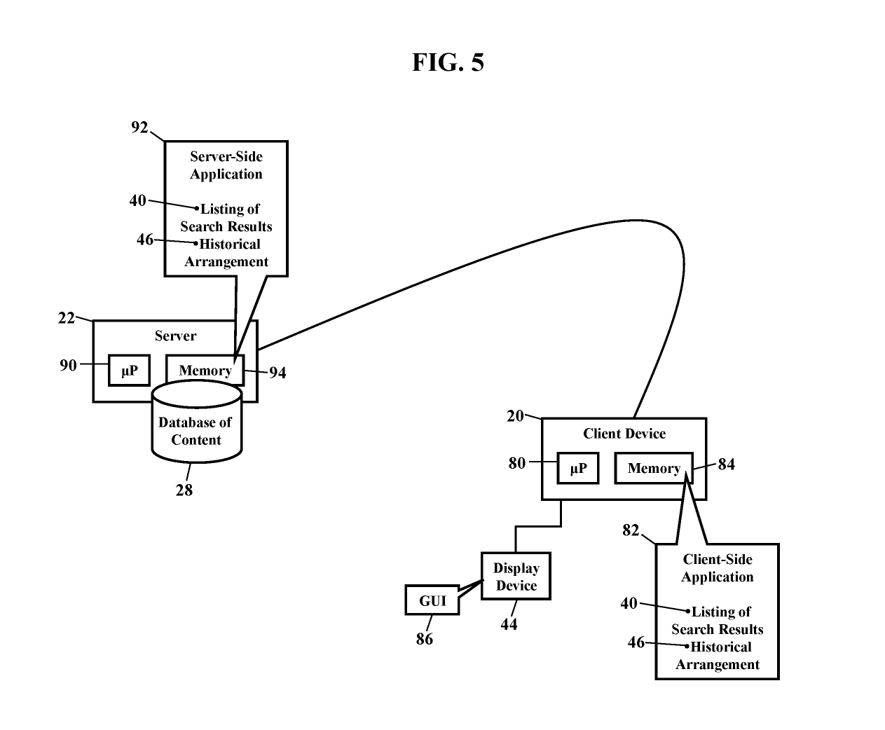

Now that exemplary embodiments have been simply described, FIG. 5 is a more detailed schematic illustrating the operating environment. Here the client device 20 is generically illustrated as any system or device having a processor 80 (e.g., “μP”), application specific integrated circuit (ASIC), or other component that executes a client-side application 82 stored in a local memory 84. The client-side application 82 may cause the processor 80 to generate the graphical user interface (“GUI”) 86 that is displayed on the display device 44 (such as a capacitive touch screen on the smartphone 20 illustrated in FIG. 1). The server 22 may also have a processor 90 (e.g., “μP”), application specific integrated circuit (ASIC), or other component that executes a server-side application 92 stored in a local memory 94. The client-side application 82 and/or the server-side application 92 include algorithms, instructions, code, and/or programs that cooperate and to perform operations, such as generating the historical arrangement 46 of the listing 40 of search results.

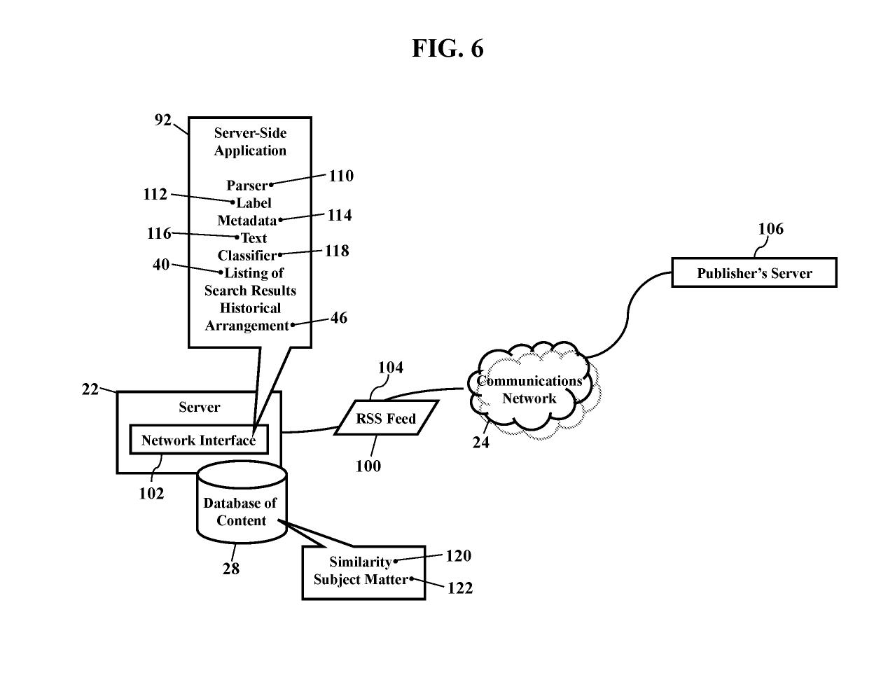

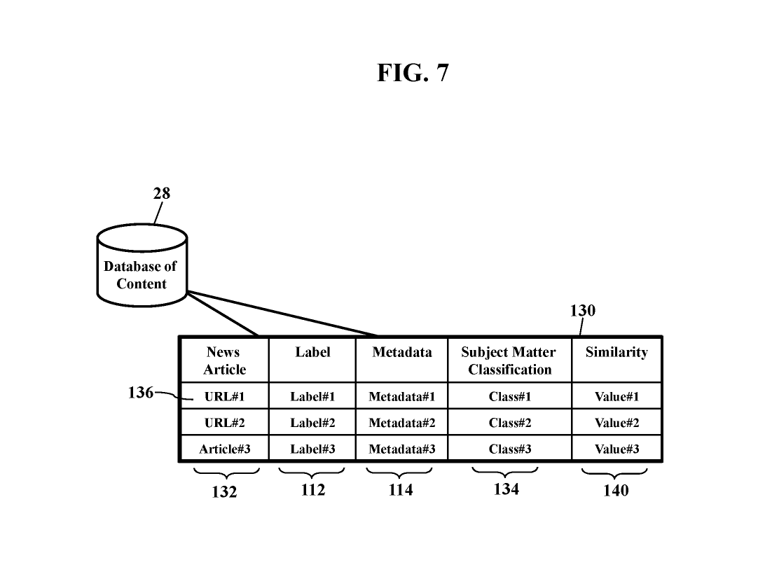

FIGS. 6 and 7 are more detailed schematics illustrating the database 28 of content, according to exemplary embodiments. FIG. 6 illustrates the server 22 receiving electronic data 100 from a network interface 102 to the communications network 24. FIG. 6 illustrates the data 100 as an electronic Rich Site Summary (or “RSS”) feed 104 sent from a network address of a publisher's server 106, in keeping with the news-oriented explanation of FIGS. 2-4. In actual practice, though, the server 22 may receive any electronic content, such as website data, blogs, scholarly articles, movies, music, or electronic scans of documents. Moreover, even though FIG. 6 only illustrates a single RSS feed 104 from a single publisher's server 106, the server 22 would likely receive many different RSS feeds from many different publishers (as FIG. 3 illustrates). Each one of the RSS feeds may be sent to the network address associated with or assigned to the server 22. Regardless, as the server 22 receives the RSS feed 104, the server 22 constructs the database 28 of content to store and retain historical information according to subject matter. Exemplary embodiments may even perform a recursive crawl on the front page of news websites (perhaps hourly or daily), thus further building the database 28 of content.

The database 28 of content is thus a corpus of news collected over time. At first the database 28 of content may start small with only a few weeks or months of articles. Over time, though, as more and more data is downloaded, the database 28 of content grows. Eventually the database 28 of content becomes a comprehensive repository of new and historical articles. As FIG. 6 also illustrates, each stored document may be submitted to a parser 110 that adds one or more labels 112. For example, each article may be associated with metadata 114 describing the originating RSS feed 104 or website, category, author, keywords, and any other descriptive information. The parser 110 then parses out the text 116 of the article for further analysis. The text 116 and/or the metadata 114 may then be used to calculate features for training a classifier 118. The classifier 118 adds classification or category information to the article, based on its text 116. The classifier 118 may use any algorithm, from a bag of words approach to linguistic approaches to statistical ones. The server 22 may thus use any one or combination of the label 112, metadata 114, text 116, and/or output from the classifier 118 to generate the historical arrangement 46 of the listing 40 of search results.

As FIG. 7 also illustrates, the article may then be added to the database 28 of content. FIG. 7 illustrates the database 28 of content as a table 130 having entries that associate each different news article 132 to its corresponding article-based features (such as the label 112, metadata 114, and/or classification 134 generated by the classifier 118 from the text 116). Each different article 132 may be uniquely identified by some identifier, such as a uniform resource locator 136 to its corresponding storage position or location. The corpus of articles in the database 28 of content may then be compared to each other, or in any combination, to determine a similarity 140 to the subject matter classification 134. For example, an article 132 that is highly relevant to the subject matter classification 134 may have a high rank or value of the similarity 140. A dissimilar or irrelevant article to the subject matter classification 134 may have a low rank or value of the similarity 140. The similarity 140 is thus some measure or level compared to the subject matter classification 134.

The database 28 of content quickly grows. As each single article may be compared to every other article in the database 28 of content, the size of the database 28 of content grows exponentially with the number of articles in the database. Exemplary embodiments may thus use distributed computing to spread the computation across multiple server machines. For example, a computational technique may use a map reduce approach whereby the computation is distributed to a number of other computers (e.g., 20), and the individual results are received and aggregated into a final result. This distributed computation may be performed using a central processing unit (CPU) of each respective computer. As another example, one or more graphic processing units (or GPUs), on a single or on the multiple computers, may be tasked with some or all of the computations. This GPU-approach works well for a finished product because of the small inputs (number of distinct articles), large number of computations to do on that data set (all pairs comparisons) and the small number of outputs (mutually exclusive grouping of articles).

Exemplary embodiments may include crowd-sourced comparisons. Once the features of an individual article are determined, exemplary embodiments may gather some or all other similar articles accessible from the Internet or other source. The classifier 118 may thus be trained with reference to crowd-sourcing data or inputs. Exemplary embodiments may thus use the distributed computing infrastructure to accomplish the similarity comparison in near-real time. A current implementation of the classifier 118 determines about twenty (20) different features for each article, using grammatical and/or non-grammatical combinations. For example, the classifier 118 may inspect the text 116 for noun head phrases and/or verbs. Moreover, the classifier 118 may inspect the text 116 for any non-grammatical combinations, such as a bag of words approach where all words are treated equally. Exemplary embodiments may use a statistical distribution of the values of the features themselves over the entire dataset as part of the criteria for the features, rather than just the values of the features compared to a threshold. Many existing approaches simply use a threshold value for determining what a cutoff value for a particular feature should be. Instead, exemplary embodiments may assign values to the features in statistical terms. For example, rather than simply using a term frequency count, weighted based on its uniqueness of the corpus, exemplary embodiment may further weight this feature based on how many standard deviations it is away from the mean value. By including these derivative features, the classifier 118 is more robust, thus generating varying levels of similarity as well as changes to the nature of the dataset.

Crowd sourcing is also scalable. Conventional machine learning classification systems tend to use either statistical analysis or manual annotation to mark ground truth. However, these conventional schemes only work with large amounts of data. Moreover, other conventional schemes use manual annotation by domain experts. To ensure consistency, the number of experts is typically kept small, but with the obvious scalability and expense issues. Here, though, exemplary embodiments are scalable, both in terms of the number of inputs that can be accommodated (e.g., pairs of articles) but also the levels of output to be mapped (e.g., different levels of the similarity 120). As a simple example, suppose there are five different scores or votes of the similarity 120. A vote of “0” or “1” implies two articles are “not related,” while votes of “2” through “4” may imply varying levels of “related.” A vote of “5” would mean the two articles have the same topic, thus meaning a strong relation. In actual practice, though, there may be many different levels of the similarity 120, thus allowing users to map a large number of articles to perhaps even thousands of varying levels of the similarity 120, depending on how many votes that particular comparison received.

This disclosure now augments the explanation with reference to FIGS. 2-4. When the user launches or opens the interface 50 (such as that generated by the client-side application 82), the smartphone 26 processes the major headlines for the day (as FIG. 2 illustrates). The user may thus peruse different headline articles and select a desired headline article of interest, such as the entry 54. Even though the user selected the single headline entry 54 (e.g., the tragic airline event), exemplary embodiments present the article of interest in the timeline 60 (as FIG. 3 illustrates). That is, the desired news article is displayed, along with the historical arrangement 46 of other articles having the same or similar subject matter classification 134 (perhaps as determined by the similarity 140). Exemplary embodiments may thus query the database 28 of content to retrieve any or all the electronic documents related to the same event as the user's selected article of interest. The number of articles to be displayed may be varied depending on a length of the time period over which the event spans. A relatively recent news event may only have a few articles, while an older news event will likely have more articles. Exemplary embodiments may thus determine a display size of the display device 44 and equally allocate display space or pixels to each one of the articles in the timeline 60 of events.

The timeline 60 of events may be further configurable. For example, if the number of articles shown is less than the total number of related articles in the database 28 of content, a metric can be used to determine which subset of articles are shown. One metric may sequentially add articles that are classified as “less similar” or even “least similar” to the current group of shown articles. This metric allows construction of a comprehensive set of articles that are both different from one another, but still pertinent to the original article. Another metric may display only a subset of articles that pertain to the user. The metric, in other words, may display links to related articles 132 not yet selected by the user for reading, and/or articles that have been published since the last time the user read about the same event subject matter. Regardless, by selecting any website link the smartphone 26 queries for and retrieves the full text of the article.

The historical arrangement 46 may have different criteria. This disclosure above explains a chronological arrangement, which will perhaps be best understood by most readers. However, exemplary embodiments may include many other measures of historical arrangement. For example, the listing 40 of search results may be historically arranged according to scholarly contribution and/or intellectual advancement. Many endeavors may be viewed as a series of advances, especially in science and medicine. Some efforts may yield more insight and advancement that other efforts. Indeed, some efforts may prove fruitless or even a setback. Exemplary embodiments may thus arrange the listing 40 of search results according to intellectual progress, perhaps presenting a hierarchical march from outlier vision to current implementation. Exemplary embodiments are thus very helpful for users in the science, medicine, legal, and financial professions where scholarly, intellectual advancements are studied and reviewed.

The listing 40 of search results may also have a sequential component. Some subject matter may be viewed as a sequence of developments, starting with some initial act or event. Indeed, many social events may be traced to a local spark or issue that grows and spreads in influence. Exemplary embodiments may thus arrange the listing 40 of search results solely or at least partially based on sequential steps from an initial event. Exemplary embodiments are thus very helpful for users in the social sciences, engineering, manufacturing, and legal professions where procedures and processes are studied.

Exemplary embodiments are also applicable to advertising efforts. Most readers understand that advertisements accompany Internet content. Indeed, the listing 40 of search results may include sponsored advertisements that are related to search keywords. However, exemplary embodiments may also include the historical arrangement 46 of sponsored advertisements. As many advertisers submit bids for placements of advertisements in the listing 40 of search results, over time the advertisements may change as advertiser-bidders come and go. When exemplary embodiments historically arrange the listing 40 of search results, the entries may also include current and/or historical advertisements and website links associated with the same search term or keyword. The advertising may be historically arranged, thus allowing the user to monitor changes in advertising schemes and the competitive bidding as time passes.

Exemplary embodiments are also applicable to archival scanning of library materials. As this disclosure intimates, any subject matter may be viewed, perhaps with hindsight, to discern important or consequential advances. History, science, and law are just some subject matter that may be reconstructed to generate a sequence or timeline of events. For example, as GOOGLE® and others continually scan library archives, papers and words may be annotated and analyzed for the historical arrangement 46. The database 28 of content may include entries that reflect the historical arrangement 46 of archival materials.

Exemplary embodiments thus present many features. As the database 28 of content may store any data on any subject, users may thus retrieve and display historical arrangements of any keyword subject matter, not just the latest headlines. Indeed, the database 28 of content may be tailored for specific subject matter, such as the medical, legal, and engineering professions above explained. Exemplary embodiments thus also include “tracking” an event of interest. As the database 28 of content adds a new entry for some subject matter, notifications may be sent to the user's smartphone 26. For example, the user may wish to be notified when new articles about some topic are published. Website links to these articles may be sent to the network address or IP address of the smartphone, thus allowing quick retrieval. Icons or other graphical features may differentiate previously read articles from new and/or unread articles.

Exemplary embodiments may include similarity features. Some users may only wish to receive links to highly similar subject matter articles. Other users, though, may be receptive to articles that stray or cross-classifications in subject matter. Exemplary embodiments may thus be configured for different values or measures of the similarity 140, such as graphical controls from “highly similar” events, to “less similar,” and perhaps even “dissimilar.” Indeed, given the very large corpus of entries in the database 28 of content, entries may even be included for obscure, off-topic, or “weird” subjects. As the database 28 of content contains entries for articles organized by the similarity 140, exemplary embodiments may also identify “orphan” news articles that are completely unrelated to any other news events. Links to these orphans may be highlighted for the user's enjoyment or presented in a different application entirely.

Exemplary embodiments are socially integrated. The user may share any historical arrangement 46 with others, such as the network addresses of their social friends and contacts. A sharing feature, for example, generates a link to a web app version. Moreover, the historical arrangement 46 may be posted or shared using social media. One aspect of the news that may be relevant is what famous personalities think of the news (e.g., TWITTER feeds). Social “tweets” and other postings may be presented alongside the historical arrangement 46 to give additional context about the event. Along the same vein, social networks may also incorporate opinions posted by friends and family.

Exemplary embodiments include still more configuration parameters. The user may personalized her categories of interest, thus excluding articles having no interest to her. The user, of course, may specify categories or topics of interest, thus tailoring the types of articles she sees for consumption. Exemplary embodiments may also track the user's selections, dwell/read time, and other behavioral metrics to predict or recommend articles and categories.

Exemplary embodiments are applicable to any computing and software platform. Exemplary embodiments, for example, have been developed for the APPLE IOS environment, but a exemplary embodiments may be applied to any mobile OS, wearable device, standalone desktop/web application or as a plug-in into an existing web application or website.

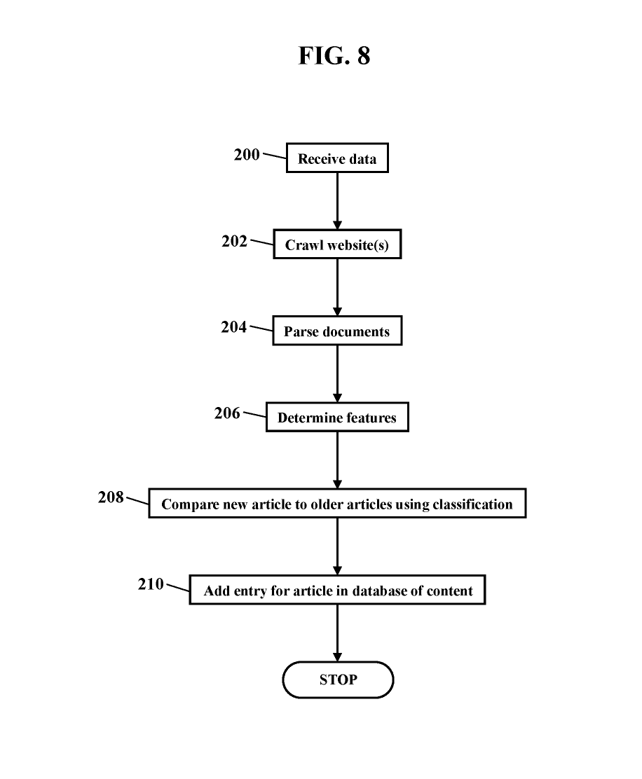

FIG. 8 is a flowchart illustrating a method or algorithm for populating the entries in the database 28 of content, according to exemplary embodiments. The data from the sources is received (Block 200). Websites may also be crawled for the data (Block 202). The data (such as news articles) is parsed (Block 204) and the corresponding features are determined (Block 206). Each newly-received article may be compared to older articles using the subject matter classification to determine the similarity (Block 208). An entry is then added to the database 28 of content database for the corresponding article (Block 210).

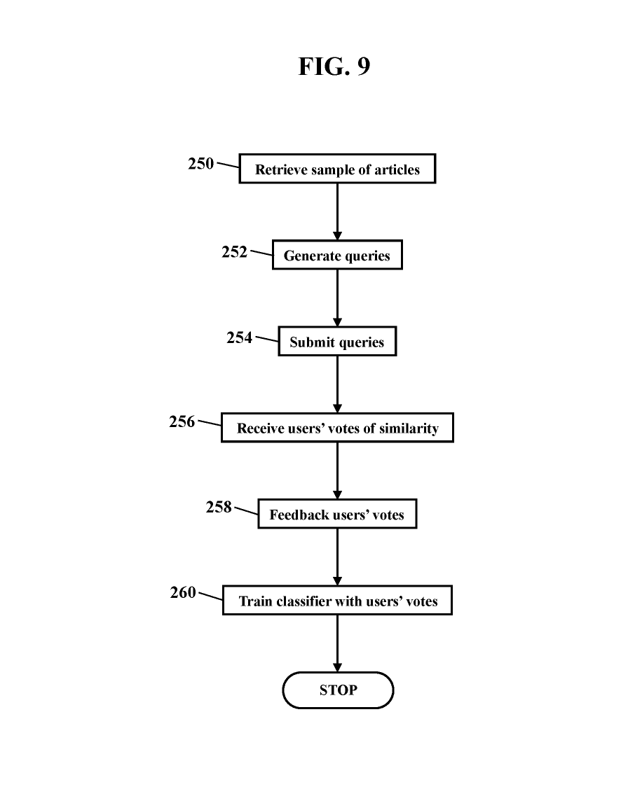

FIG. 9 is a flowchart illustrating a method or algorithm for training the classifier 118, according to exemplary embodiments. Here the classifier 118 may classify an electronic article or other document according to users' votes or recommendations (e.g., crowd-sourcing). A subsample of articles in the database 28 of content may be retrieved, perhaps based on a predictive analysis using the different features or similarity (Block 250). One or more queries may be generated based on the subject matter classification and/or the similarity (Block 252). The queries are submitted to a population of the users (Block 254), and the users' votes are received (Block 256). For example, each user may submit her vote or level of the similarity between two or more of the articles in the subsample. The users' votes may then be used as feedback to the classifier 118 (Block 258). The users' votes may be compared to the different features and/or the similarity, as determined by the classifier 118, for training purposes (Block 260).

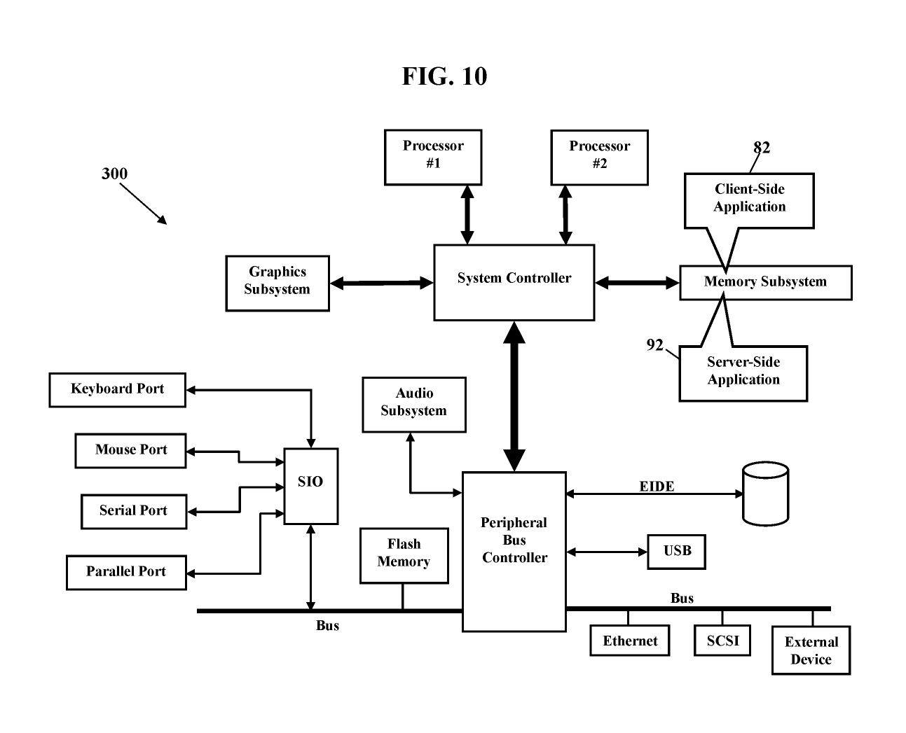

FIG. 10 is a schematic illustrating still more exemplary embodiments. FIG. 10 is a more detailed diagram illustrating a processor-controlled device 300. As earlier paragraphs explained, exemplary embodiments may operate in any processor-controlled device. FIG. 10, then, illustrates the client-side application 82 and/or the server-side application 92 stored in a memory subsystem of the processor-controlled device 300. One or more processors communicate with the memory subsystem and execute either or both applications. Because the processor-controlled device 300 is well-known to those of ordinary skill in the art, no further explanation is needed.

Exemplary embodiments may be physically embodied on or in a processor-readable device or storage medium. For example, exemplary embodiments may include CD-ROM, DVD, tape, cassette, floppy disk, optical disk, memory card, memory drive, and large-capacity disks.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method, comprising:
receiving, by a server, an electronic news feed comprising an electronic article;
parsing, by the server, text associated with the electronic article in the electronic news feed;
classifying, by the server, the text associated with a subject matter;
adding, by the server, a website link to an electronic database of content, the electronic database of content storing website links to electronic articles in electronic association with different subject matter, the electronic database of content electronically associating the website link to the subject matter associated with the text associated with the electronic article in the electronic news feed; and
adding, by the server, the website link to an historical arrangement of the website links also associated with the subject matter.

2. The method of claim 1, further comprising historically arranging the electronic article according to a date of publication.

3. The method of claim 1, further comprising historically arranging the website link according to a date of publication associated with the electronic article.

4. The method of claim 1, further comprising generating an electronic timeline that chronologically arranges the website links according to dates of publication.

5. The method of claim 1, further comprising generating an electronic timeline that chronologically arranges the website links according to dates of publication associated with the electronic articles.

6. The method of claim 1, further comprising historically arranging the electronic article according to a scholarly contribution.

7. The method of claim 1, further comprising historically arranging the electronic article according to sequential steps from an initial event.

8. A system, comprising:
a processor; and
a memory storing instructions that when executed cause the processor to perform operations, the operations comprising:
receiving an electronic rich site summary feed comprising an electronic article associated with a date of publication;
parsing text associated with the electronic article in the electronic rich site summary feed;
classifying the text associated with a subject matter;
adding a website link to an electronic database of content, the electronic database of content storing website links to electronic articles in electronic association with dates of publication and with the subject matter, the electronic database of content electronically associating the website link to the date of publication and to the subject matter associated with the text associated with the electronic article in the electronic rich site summary feed; and
historically arranging the website link within the website links to the electronic articles also classified in the subject matter.

9. The system of claim 8, wherein the operations further comprise arranging the electronic article with the electronic articles according to the date of publication.

10. The system of claim 8, wherein the operations further comprise arranging the website link according to the date of publication associated with the electronic article.

11. The system of claim 8, wherein the operations further comprise generating an electronic timeline that chronologically arranges the website links according to the dates of publication.

12. The system of claim 8, wherein the operations further comprise generating an electronic timeline that chronologically arranges the website links according to the dates of publication associated with the electronic articles.

13. The system of claim 8, wherein the operations further comprise historically arranging the electronic article according to a scholarly contribution.

14. The system of claim 8, wherein the operations further comprise historically arranging the electronic article according to sequential steps from an initial event.

15. A memory device storing instructions that when executed cause a processor to perform operations, the operations comprising:
receiving an electronic rich site summary feed comprising an electronic article associated with a date of publication;
determining a website link associated with the electronic article;
parsing text associated with the electronic article in the electronic rich site summary feed;
classifying the text associated with a subject matter;
adding the website link to an electronic database of content, the electronic database of content storing web site links to electronic articles in electronic association with dates of publication and with the subject matter, the electronic database of content electronically associating the website link to the date of publication and to the subject matter associated with the text associated with the electronic article in the electronic rich site summary feed; and
historically arranging the website link in the electronic database of content in relation with the web site links to the electronic articles also classified in the subject matter.

16. The memory device of claim 15, wherein the operations further comprise arranging the electronic article with the electronic articles according to the date of publication.

17. The memory device of claim 15, wherein the operations further comprise arranging the website link according to the date of publication associated with the electronic article.

18. The memory device of claim 15, wherein the operations further comprise generating an electronic timeline that chronologically arranges the website links according to the dates of publication.

19. The memory device of claim 15, wherein the operations further comprise generating an electronic timeline that chronologically arranges the website links according to the dates of publication associated with the electronic articles.

20. The memory device of claim 15, wherein the operations further comprise historically arranging the electronic article according to a scholarly contribution.
